(19) United States
(12) Patent Application Publication
(10) Pub. No.: US 2017/0132541 A1
(43) Pub. Date: May 11, 2017

(54) SYSTEMS AND METHODS FOR CROWD-SOURCING PARKING SPACE

(71) Applicant: Charles F. Myers, Midlothian, VA (US)

(72) Inventor: Charles F. Myers, Midlothian, VA (US)

(21) Appl. No.: 14/937,796

(22) Filed: Nov. 10, 2015

(51) Int. Cl. G06Q 10/06; G06F 17/30; G01C 21/36; H04W 4/02

(52) U.S. Cl. CPC G06Q 10/06311; H04W 4/023; G06F 17/30864; H04W 4/025; G01C 21/3667; G06Q 50/30

(57) ABSTRACT

Systems and methods are disclosed for generating a trucker parking report on available parking space(s) by receiving crowd sourced data from a computing device associated with a trucker traversing a travel route, the crowd sourced data including location data and available parking data associated with the user; verifying accuracy and timeliness of the crowd sourced parking data, generating a truck parking report based on the crowd sourced data, and displaying the truck parking report on the computing device.

### BACKGROUND

The present application relates to systems and methods for crowd-sourcing truck parking space.

A supply chain is the mechanism through which a product goes from a manufacturer to a consumer and may include a set of suppliers, manufacturers, wholesalers, distributors and stores that enable a product to be made, sold and delivered to the eventual customer. A common way is to transport products using trucks or rigs. As trucks form the backbone of the supply chains and truckers typically drive 10-11 hours per day and need resting places. While big rigs contain sleeping quarters in them, truck drivers still need to get a place to park every night. States are frequently shutting down designated trucks rest stops along throughways to cut costs, forcing truckers to park in empty parking or interstates to get a night rest.

Long haul truck drivers usually compete for a space at truck stops as they look for places to sleep safely. According to national transportation safety board, estimated 167,000 out of 185,000 open spot for trucks to stop are usually filled on nightly basis. This leaves close to 20 thousand spots, but a truck driver might be million miles away from these spots, creating a problem when a driver gets back to driving the following day.

### SUMMARY

Generally, the architecture employs crowd-sourced parking-related information to find truck parking spots at parking lots and/or rest areas.

In one aspect, systems and methods are disclosed for generating a trucker parking report on available parking space(s) by receiving crowd sourced data from a computing device associated with a trucker traversing a travel route, the crowd sourced data including location data and available parking data associated with the user; verifying accuracy and timeliness of the crowd sourced parking data, generating a truck parking report based on the crowd sourced data, and displaying the truck parking report on the computing device.

Advantages of the system may include one or more of the following. The system guides drivers to parking locations where the drivers are likely to find high quality parking spots suitable for trucks and rigs. The system reduces the amount of time required to find a truck parking area. The recommended truck parking is typically high quality because they are recommended by truckers for truckers. The ecosystem near the parking area is also convenient and accessible to truckers. To achieve this, the architecture utilizes crowd-sourcing parking availability statistics truckers and geolocation data (e.g., geographical coordinate computing systems such as global positioning system (GPS)data) and other sources of information such as sensors (e.g., an inertial sensor such as an accelerometer, gyroscope, etc.) that may be available on the user's mobile device (e.g. smartphone) or onboard vehicle device.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a method for truck parking space reporting using crowd sourced data.

FIG. 2 illustrates a system used for generating a truck parking space report using crowd sourced data.

FIG. 3 shows an exemplary user interface for the truck parking space system of FIG. 1.

FIG. 4A is an exemplary crowd-sourced parking area recommendation system for truckers.

FIG. 4B shows more details of the crowd-sourced parking area recommendation system for truckers.

FIG. 4C shows an exemplary process for crowd-sourced parking area discovery and recommendation for truckers.

FIGS. 5A-5C show another embodiment of a truck parking space recommendation system.

### DETAILED DESCRIPTION

Embodiments of the present invention may provide a truck parking space reporting service that uses crowd sourced data to generate more accurate and complete truck parking space reports.

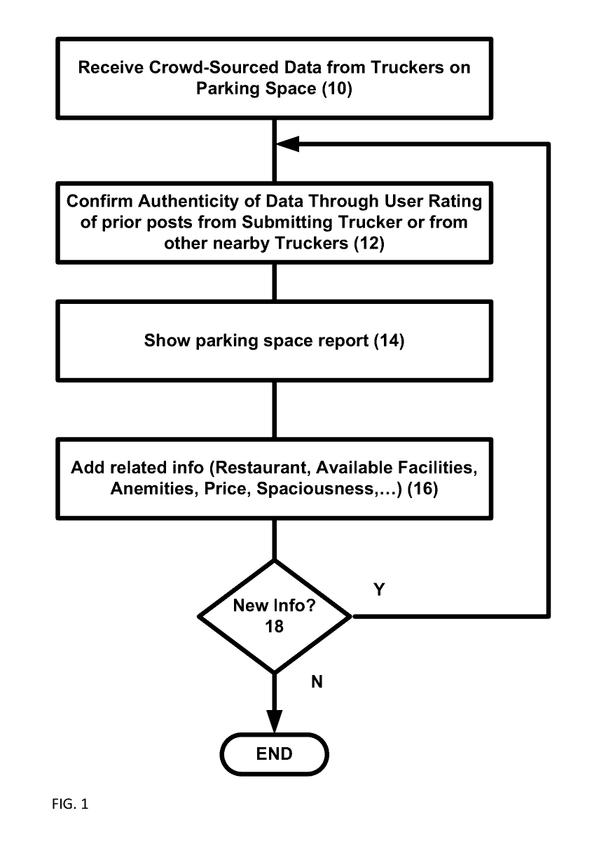

FIG. 1 illustrates a method for truck parking space reporting using crowd sourced data. The steps identified in FIG. 1 (and the order thereof) are exemplary and may include various alternatives, equivalents, or derivations thereof including but not limited to the order of execution of the same. The steps of the method of FIG. 1 (and its various alternatives) may be embodied in hardware or software including a non-transitory computer-readable storage medium (e.g., an optical disc or memory card) having instructions executable by a processor of a computing device.

A truck driver (user) may launch or activate the method of FIG. 1 by opening or activating an application in a computing device such as a smart phone or suitable mobile device. At 10, crowd sourced data on available parking space from a plurality of truckers is received at a trucking application server 160 from a computing device 108 associated with a truck driver or user. The user may authorize the collection of crowd sourced data via a mobile based computing device 108 or one that otherwise generates location based data (e.g., GPS, base station identification, triangulation data, etc.). Computing device 108 may receive user authorization and transmit collected crowd sourced data to application server 160 for processing by way of a user 110 offering certain permissions on the device 108.

Crowd sourced data may be an indicator of traffic conditions when it includes traffic data about a non-sensored thoroughfare or roadway that is not available by another means. Crowd sourced data may include data collected by active means as well as passive means. Passive crowd sourced data may include, for example, non-personally identifiable data such as location information, geographic coordinate data (e.g., latitude/longitude), timestamp data, heading information, and floating car data, which is sometimes referred to as floating cellular data. Location may be determined by any positioning technology known in the art such as global navigation satellite systems (e.g., GPS or GNSS), real-time locating systems, or local positioning systems. Floating car data may include speed data, direction of travel information, time information, or other information received from a computing device (e.g., mobile phone).

Traffic data from information sources 130 may also be received at application server 160. Traffic data from information sources may come from public agencies (e.g., U.S. Department of Transportation, local police departments) or private entities (e.g., Inrix, TrafficCast, Clear Channel). Traffic data may include incident data, speed information, flow information, or information from traffic cameras or videos. Speed and flow information may be obtained from various kinds of detector equipment along highways or roadways such as loop detectors and other magnetic sensors, radar detectors, toll tag readers, Bluetooth traffic monitoring devices, or video vehicle detectors. Data from traffic cameras and video cameras may be obtained from roadside cameras, in-vehicle cameras, or the like, and may capture live videos, snapshots, and images of actual driving conditions. In addition to providing a glimpse of real-time traffic conditions, these cameras may also show the effects of weather on traffic.

At 12, the received crowd sourced data is verified for timeliness to optimize latency and ensure the relevance or accuracy of the data. The accuracy can be determined in various ways. For example, prior user postings relied on by other trucker can be used as an indicia of trustworthiness that can be relied on. If multiple truckers report similar parking space availability, that is another indicia of trustworthiness. If the business at the parking location actively indicates available space, that is another indicia of accuracy, unless the business has a history of overbooking in which case the system would downgrade that indicia.

To obtain the most accurate and complete depiction of actual traffic conditions, the most recent, up-to-date crowd sourced data is desired. For example, crowd sourced data that is 8 hours old may no longer be irrelevant. Application server 160 may process the crowd sourced data and share the crowd sourced data with other users in the network. The received crowd sourced data may include location information and amenity information such as shower rooms, food, among others.

Next, at 14, application server 160 generates a truck parking space report based on the crowd sourced data. In one embodiment application server 160 generates the truck parking space report based on seasonality, weather and traffic data received from information sources 130 in addition to crowd source data. The generated truck parking space report may also be based on other relevant information such as weather information or forecasts, or newsworthy events such as concerts, sporting events, street closures, or protests that may impact parking space availability.

A generated truck parking space report may include point-to-point trip times, trip time predictions for a travel route, and recommended departure times for various times and days of the week. Application server 160 may calculate point-to-point trip times based on starting and end points provided by user 110. When calculating point-to-point trip times, a starting point may be the real-time location of computing device 108. Application server 160 may also calculate or predict trip times for a particular travel route based on crowd sourced data, traffic data from information sources 130, or combinations of the same.

The system can use traffic reporting applications from traditional traffic sources such as public sector and private entity sources. These applications typically do not consider crowd sourced data that can provide updated or real-time traffic data not otherwise available from traditional sources. One mobile application, called “Waze” (available from Waze Ltd.), automatically collects traffic data and road condition information from users as they drive. “Waze” relies primarily on crowd sourced data to present updated traffic information to users of the application. Based on traffic information received from various sources (e.g., crowd sourced data and/or traffic data) application server 160 may further calculate and recommend a departure time for timely traversing a route when user 110 has indicated a desired arrival time at the parking or rest area. Application server 160 may also calculate and recommend departure times for different days or times of the week based on historical or forecasted traffic information received from information sources 130.

At 14, application server 160 displays the truck parking space report on computing device 108. A generated truck parking space report that is displayed at step 14 may convey a variety of traffic information in different forms or formats. A truck parking space report may be textual or graphical or include combinations of the same. A truck parking space report, for example, may be generated and displayed in the form of a map of particular area and may include textual and/or graphical information about traffic conditions, incidents, or hazards along a travel route. A truck parking space report may also be generated and displayed in a textual/list format showing, for example, frequently traveled routes, the predicted travel time or recommended departure time for each route, and any notable traffic conditions or incidents affecting the route. Travel times or departure times for a particular route may be also be displayed in graphical form with time of day on the x-axis plotted against travel time in minutes on the y-axis. User 110 may use the various information presented in the truck parking space report to make an informed decision about which travel route to take and/or the best departure time to reach a destination. The report may be three-dimensional, include areas for advertising, or be subject to multiple points of view that can be rotated through touch screen controls or multi-finger touch/pinch control.

At 16, the process adds related information such as the name of the truck stop chain, the restaurants, available facilities and amenities, for example. Smaller truck stops might consist of only a parking area, a fueling station, and perhaps a diner restaurant. Larger truck stops might have convenience stores of various sizes, showers, a small video arcade, and a TV/movie theater (usually just a projector with an attached DVD player). The largest truck stops might have several independent businesses operating under one roof, catering to a wide range of travelers' needs, and might have several major and minor fast-food chains operating a small food court. Larger truck stops also tend to have full-service maintenance facilities for heavy trucks, as well as vehicle wash services that can handle anything from passenger vehicles to large trucks. Some truck stops operate motels or have them adjacent. Most truck stops now offer separate fueling areas, often with dedicated entrances, for standard-sized passenger vehicles. The truck refueling area almost always offers dual pumps, one on each side, so large trucks can fill both tanks at once.

In one embodiment, when an individual looks at a particular location to view detail information he will get an initial screen that uses first, second and third colors to indicate the status of parking at that location. Green means there is plenty of parking, yellow means that there is a limited number of spaces and red means the lot is full. If you get on the app and pull up a Pilot truck stop you can see the initial screen and then touch it one more time to drill down to the detail information.

Other ancillary information can include the following. The retail stores in large truck stops offer a large selection of 12-volt DC products, such as coffee makers, combo television units, toaster ovens, and frying pans primarily targeted towards truck drivers, who often spend extended periods of time on the road. Such shops generally offer a wide selection of maps, road atlases, truck stop and freeway exit guides, truck accessories (such as CB radio equipment and hazmat placards), plus entertainment media such as movies, video games, music, and audiobooks. Increasingly, as interstate truck drivers have become a large market for satellite radio, these retail stores also sell various satellite radio receivers for both XM and Sirius as well as subscriptions to those services. Kiosks run by cellular phone providers are also common. Most long-haul tractors have sleeping berths, and many truck drivers keep their diesel engines running for heating or cooling for the sake of comfort. Because idling diesel engines make considerable noise (and are a source of pollution) they are often banned from such use near residential areas. Truck stops (along with public rest stops) are the main places where truck drivers may rest peacefully, as required by regulations. Modern innovations, such as truck heaters and auxiliary power units, are becoming more common, and some truck stops now provide power, air conditioning, and communications through systems such as IdleAire. Many truck stops have load board monitors for truck drivers to find real time information on loads, jobs, weather and news. The information is displayed to the user on a mobile device 108. The process continually checks for fresh information from the trucker crowd and provides updated trucker parking information.

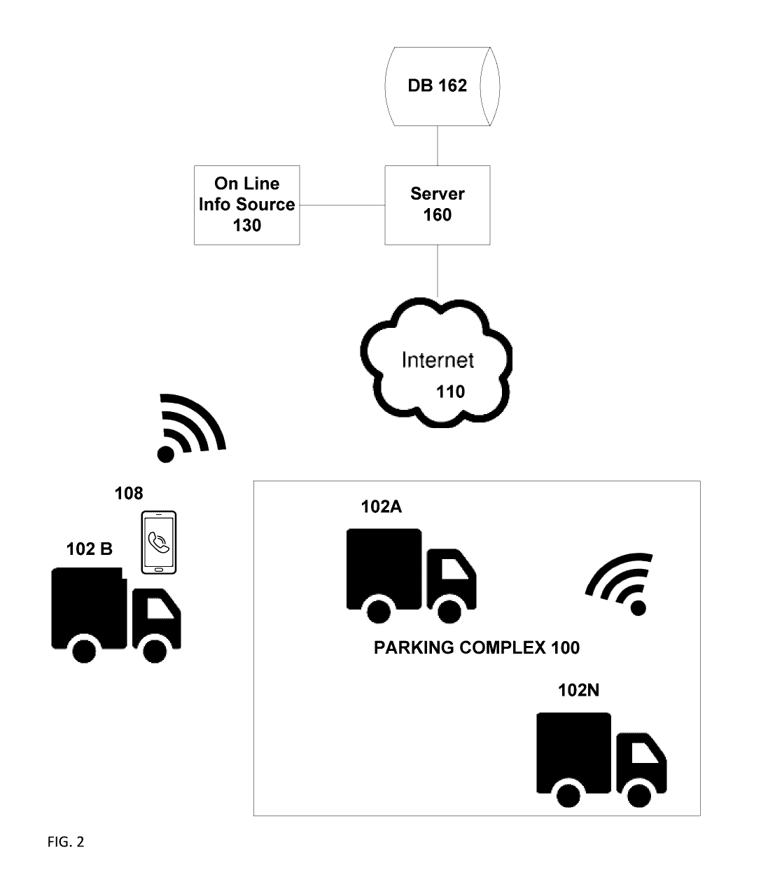

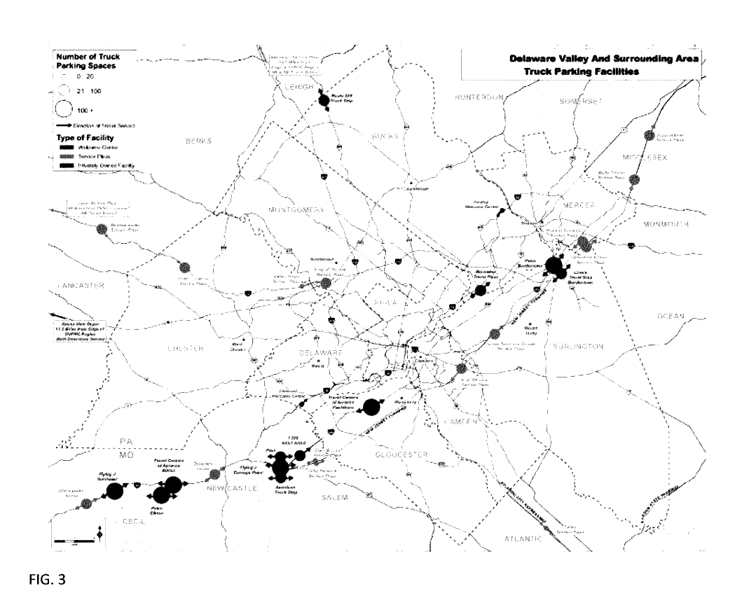

FIG. 2 illustrates a system that may be a system used for generating a truck parking space report using crowd sourced data. The system 100 of FIG. 1 includes user or driver 110, computing device 108, information source 130, network 140, application server 160, and database 170. System 100 may include a number of users and computing devices that operate in conjunction with a truck parking space reporting service. User 110 may subscribe (e.g., create an account) or register with the truck parking space reporting service provided by application server 160 via computing device 108. Once user 110 has registered with the truck parking space reporting service, user 110 may perform a login operation (i.e., access account) and may access the truck parking space reporting service to receive truck parking space reports, forecasts, and maps, and alerts of traffic incidents and delays. User 110 may also create travel routes and obtain personalized truck parking space reports for the same. User 110 may also request access to and view live or historic feeds from particular traffic cameras.

When registering with the truck parking space reporting service, user 110 may be required to input or provide (via computing device 108) registration information or user data including but not limited to name, user ID, password address, phone number, e-mail address, birthday, age, and gender. User 110 may also provide other data (e.g., start and end points) relating to one or more traffic routes. User 110 may then receive personalized truck parking space reports for frequently traversed routes such as home to office, office to home, home to school, etc.

User 110 may also provide preferences such as a preference for a type of rest facility or parking facility. For example, user 110 may indicate a preference to receive an alert of available parking areas that may appear on a frequently traversed route, a selected route, or current route. A user preference may also include a preference for or bookmark for a particular traffic camera or latest snapshot or video from a traffic camera for the selected route.

User registration information, user preferences, and route information may be used to generate a profile of user 110 which may be used to customize truck parking space reports and alerts for user 110. For example, user 110 may indicate a desire to receive a traffic alert concerning a particular travel route, geographical location, or specific road or highway. User route data and profile information may be stored in database 170.

System 100 may include database 170 for storing data. Database 170 may store route information, profile information, traffic data from information sources 130, and other data for use with the truck parking space reporting service provided by application server 160. Database 170 may be separate from or integrated with application server 160. Database 170 may be a single database server or distributed amongst a series of servers. Database 170 may also store any updates to user data, route information, or traffic data received from/provided by user 110 or information sources 130.

The information sources 130 may be provided by various organizations (public or private entities) and in a variety of forms. The information sources 130 may also include data sources related to newsworthy events or incidents such as school closings, election results, and other information that may be featured or relevant in a truck parking space report. The information sources 130 may require subscription or authentication for access and may be accessible via Telnet, FTP, or web services protocols. The information may be received from the information sources 130 in real-time or near real-time to allow for generation of an equally real-time or near real-time presentation. Information sources 130 may also include local memory storing previously received data or an antenna receiver in the likes of a GPS device that is actively or occasionally receiving data from a still separate source of data.

In an embodiment of the present invention utilizing traffic data specific to the San Francisco Bay area, for example, the information sources 130 may include one or more of the 511.org system (a collaboration of public agencies including the California Highway Patrol, Metropolitan Transportation Commission, and CAL TRANS), the California Highway Patrol (CHP) World Wide Web server, the PeMS system at the University of California at Berkeley, various public event listings, or a publicly or privately accessible user input mechanism. For weather data, the information sources 130 may include the National Weather Service among other weather information sources. Other data sources or alternative types of data sources (e.g., non-traffic and non-weather related sources) may be incorporated and utilized in various embodiments of the present invention.

The system can further comprise inferring temporal information related to the parking based on the geolocation data. The temporal information can include time information for the parking activity for a given parking area at all times of the day, week, month, etc., and time restrictions (e.g., no parking during the day during 6 AM-6 PM). This restriction data can be obtained from websites that provide such information, from users that may provide such information as feedback via a user profile, user preferences, etc., for example. This time restriction information can be derived based on repeated use of the parking spaces by truckers over time. That is, if truckers who park in an area are detected as routinely leaving that parking area at a given time (e.g., other than end of day), it can be inferred that there is a time restriction for that parking area. The method can further comprise inferring a maximum time allowed for the parking based on the geolocation data. The maximum time can be derived by analyzing the start time of the park activity and end time of the park activity over many parking truckers. The method can further comprise accessing other information, other than the geolocation data, that affects parking in the geographical area, and computing the parking availability probabilities based on both the geolocation data and the other information. This other information includes, but is not limited to, weather data sources, road construction data sources, inertial sensor data (e.g., accelerometer, gyroscope, images, processed audio (e.g., traffic sounds, construction sounds, heavy equipment sounds), user input, social media message content, blog content, emails, event information, etc.).

Computing device 108 is inclusive of a general purpose computing device capable of accessing information over a network. Computing device 108 may be any computing device known in the art such as a workstation, laptop computer, net book computer, tablet computer, mobile device, cellular telephone, or the like that can communicate over network 140. Computing device 108 may include software and/or hardware capable of sending, receiving, and processing data such as crowd sourced data, traffic data, or user profile data. Computing device 108 may receive data from user 110 and send the data over network 140 to application server 160 for processing. Computing device 108 may also offer location-based information such as that generated through cellular network base stations, IP network access, or GPS data.

Application server 160 may be implemented in a general computing device that otherwise communicates with database 170 and network server 150. The present truck parking space reporting service may be implemented by one or more processors that execute instructions stored in one or more memory mediums. The executed instructions may result in the processor(s) generating and providing one or more graphical interfaces.

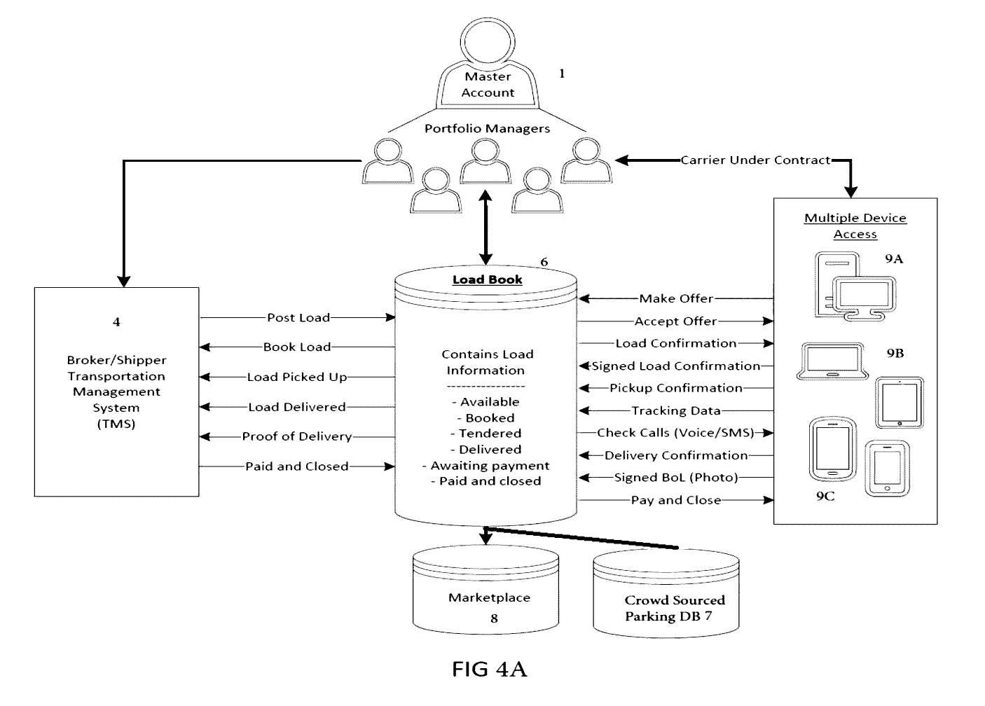

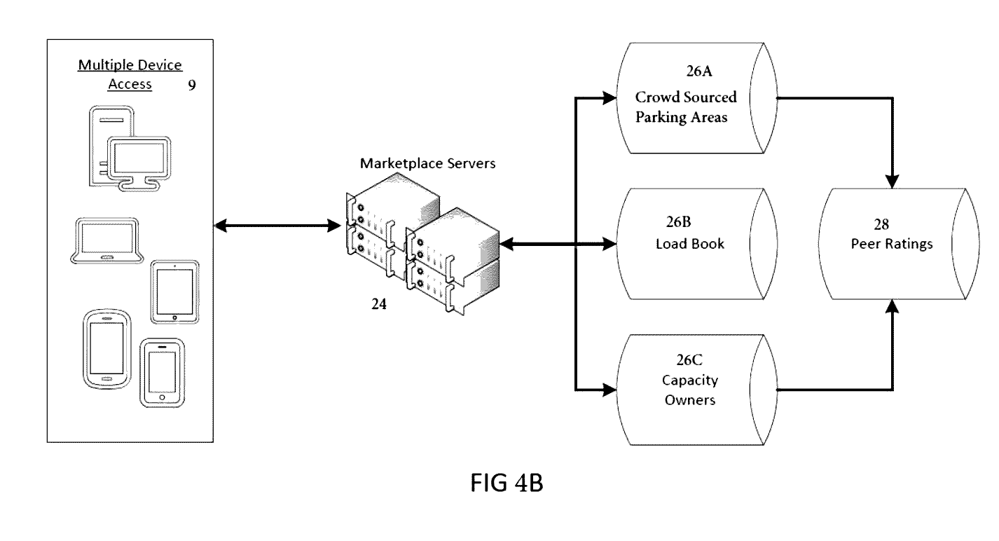

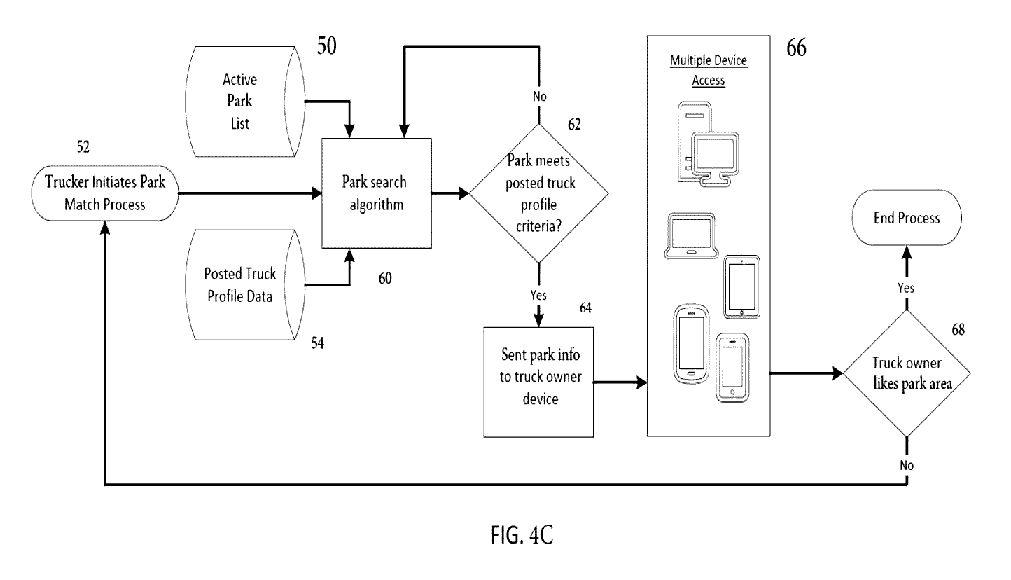

FIG. 4A is an exemplary crowd-sourced parking area recommendation system for truckers. According to one exemplary embodiment, the shippers/brokers can have a master account 1 with a plurality of portfolio managers communicating with truckers/carriers using a client-server architecture that includes a load book 6. The portfolio managers can communicate through a transportation management system (TMS) 4 the communicates with the load book 6 information such as load posting, load booking, load pickup and delivery information, payment information, and case closing operations. The trucking commerce platform, in the exemplary form of a network-based marketplace supported by data mart 8, provides server-side functionality, via a network (e.g., the Internet) to one or more clients. FIG. 4A illustrates, for example, a web client and a programmatic client executing on respective client machines 9A, laptops 9B and mobile devices 9C. The client machine can be a desktop computer for brokers and customers, or can be laptops or mobile phones for truckers. The truckers or carriers can make/accept offer, confirm load pick up, send tracking data, check for calls, provide delivery confirmation, and acknowledge payment and contract closure, among others. A parking area database 7 is provided to capture crowd-sourced rating/recommendation of parking areas for truckers by other truckers.

FIG. 1B shows more details of the network-based trucking marketplace with parking area recommendations, where a marketplace server 24 is coupled to, and provides programmatic and web interfaces respectively to, one or more database (DB) servers including parking area DB 26A, load book DB 26B, capacity owner DB 26C, all of which communicate with a peer rating DB 28. Trucking service TruckerPath server is a computer system that provides support for functions as required by trucking service Web site host, such as receiving and processing transaction requests received by trucking service Web site host.

The marketplace server 24 provides a number of marketplace functions and services to users that access the marketplace 24. The payment applications likewise provide a number of payment services and functions to users. The payment applications may allow users to quantify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications. Further, while the trucking service system shown in FIG. 4A-4B employs client-server architecture, the present system is of course not limited to such an architecture, and could equally well find application in a distributed, or peer-to-peer, architecture system. The various marketplace applications could also be implemented as standalone software programs, which do not necessarily have networking capabilities.

The mobile or web client, it will be appreciated, accesses the various shipping service marketplace and payment application via the web interface supported by the web server 26. Similarly, the mobile or web client accesses the various services and functions provided by the marketplace and payment applications such as a trucking application (e.g., the TruckerPath application developed by TruckerPath Inc., of San Jose, Calif.) to enable truckers to author and manage truck service listings on the marketplace in an off-line manner, and to perform batch-mode communications between the programmatic client and the network-based marketplace.

Other third party applications can access the server and may, utilizing information retrieved from the network-based marketplace 8, support one or more features or functions on a website hosted by the third party. The third party website may, for example, provide one or more promotional, marketplace or payment functions that are supported by the relevant applications of the network-based marketplace 8. The network-based marketplace 8 itself, or one or more parties that transact via the marketplace 8 may operate loyalty programs that are supported by one or more loyalty/promotions applications. For example, a shipper or broker may earn loyalty or promotions points for each transaction established and/or concluded with a particular Trucker, and may be offered a reward for which accumulated loyalty points can be redeemed.

FIG. 4C shows an exemplary process for crowdsourced parking area discovery and recommendation for truckers. The process provides an active load list 50 into a parking area search unit 60. A new parking match request 52 is provided to the parking area search unit 60, as is truck profile data 54. The parking search unit 60 checks if a particular parking area meets a selected truck profile criteria in 62. If not, the next available area is search by unit 60, and otherwise in 64 the process sends available parking areas to multiple device access 66 such as a truck driver's smart phone, for example. The phone checks if the driver likes a particular parking area recommendation and does not need additional parking searches in 68. In this operation, the trucker can rate the parking area and the reasons the trucker likes or dislikes the parking area and the trucker's action speakers louder than any recommendation and additionally the truck profile is updated to indicate that the trucker is still looking for a suitable parking area, and otherwise the process exits.

The system initiates a rating request upon arrival at a parking area to the trucker. The system then compiles ratings and updates a display for the parking area before exiting the process. Feedback leaving client 9A, 9B or 9C enables a user who wants to leave feedback to interact with the trucking service system. In one embodiment, the feedback viewing client is a computer system that enables a user who wants to view feedback to interact with the trucking service system. Network is a communications network, such as a LAN, WAN, intranet or the Internet. Trucking service Web site host is a system for hosting an trucking service Web site, such as an online auction or trading Web site. Trucking service Web server is a computer system that provides World Wide Web services, for example, to deliver Web pages using a markup language.

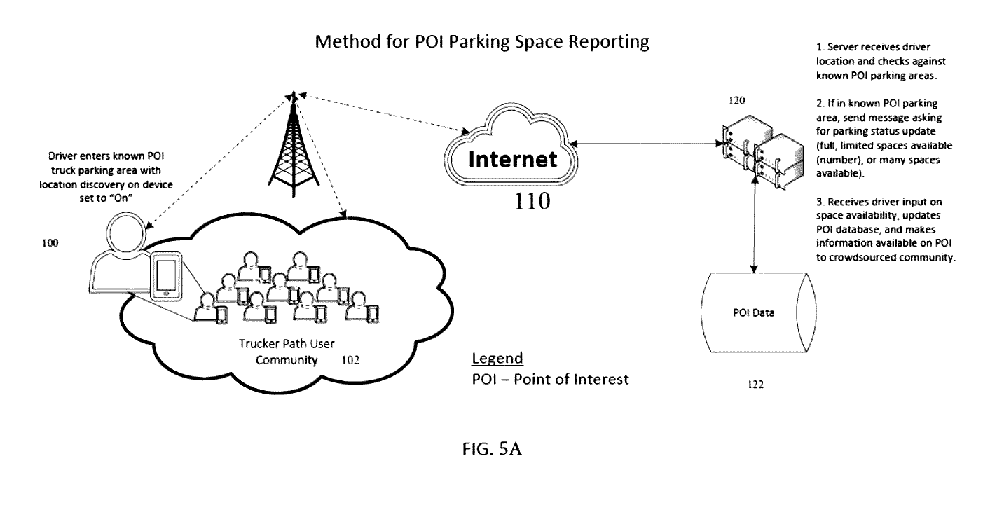

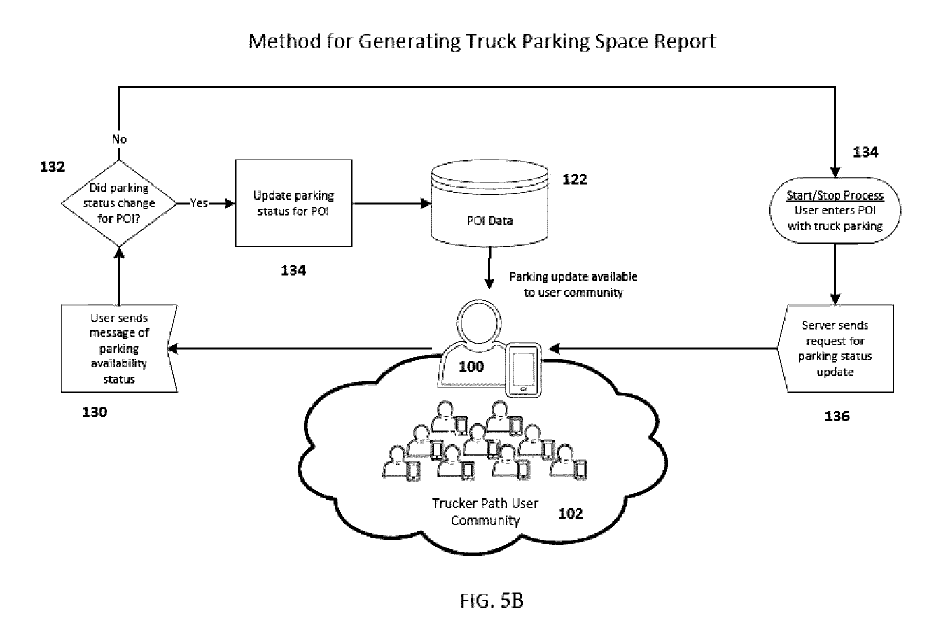

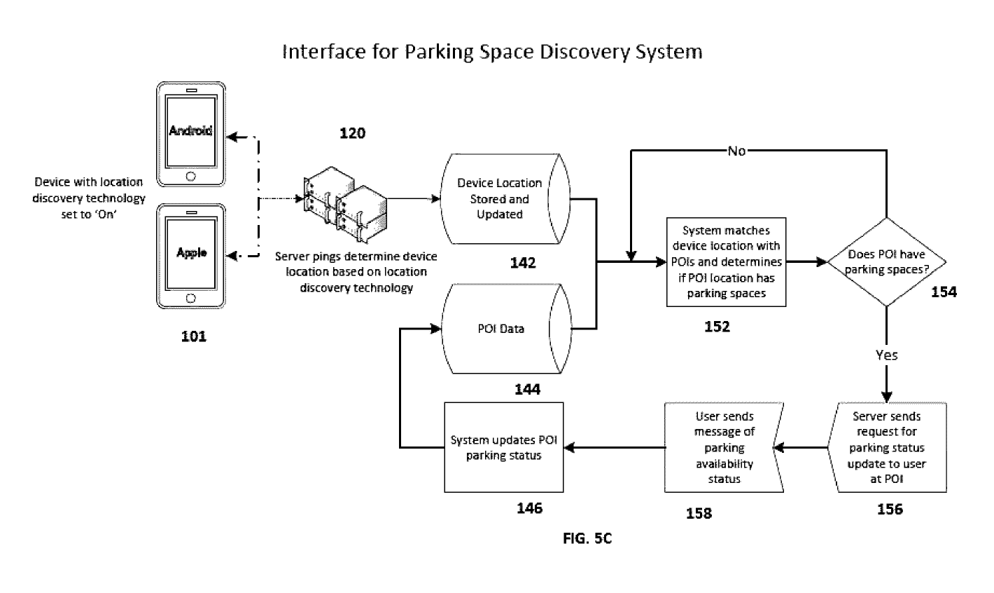

FIGS. 5A-5C show another embodiment of a truck parking space recommendation system. In FIG. 5A, a driver 100 enters a point of interest (POI) truck parking area with discover turned on. The driver 100 receives data from a trucker community 102 via mobile connections or Internet connections 110. A server 120 receives the driver location and checks against POI database 122 and reports or recommends appropriately. If in known POI parking area, the driver mobile device sends message asking for parking status update (full, limited spaces available (number), or many spaces available). The server 120 receives driver input on space availability, updates POI database, and makes information available on POI to crowdsourced community.

FIG. 5B shows an exemplary method for generating truck parking space report. The user 100 in the community 102 sends a message checking parking availability (130). The system checks for parking status change in the POI database (132) and if so updates the parking status for the POI (132) in the POI database 122, which in turn makes the parking update available to the community 102. From 132, if parking status does not change, the system detects if the user has entered a POI with truck parking space (134), and the server sends a request for parking status update (136).

FIG. 5C shows an exemplary interface for the parking space discovery and recommendation system. The user sets the mobile device 101 to provide location discovery. The information is provided to the server 120 which pings the devices to determine device location based on the location discovery. The mobile devices are carried by truckers and thus reflect the position of the trucks. The device location is stored and updated (142) along with POI data (144). From 142-144, the system matches the device location with POIs and determines if the POI location has parking spaces (152). If the POI has parking spaces in 154, the server sends requests for parking status update to the user at the POI (156) and the user in turn sends messages relating to the parking availability status (158) and the system updates the POI parking status and saves the update in the POI data 144. In 154, if the POI does not have available parking spaces, the process loops back to 152 to try another match.

The system guides drivers to parking locations where the drivers are likely to find high quality parking spots suitable for trucks and rigs. The system reduces the amount of time required to find a truck parking area. The recommended truck parking is typically high quality because they are recommended by truckers for truckers. The ecosystem near the parking area is also convenient and accessible to truckers. To achieve this, the architecture utilizes crowd-sourcing parking availability statistics truckers and geolocation data (e.g., geographical coordinate computing systems such as global positioning system (GPS)data) and other sources of information such as sensors (e.g., an inertial sensor such as an accelerometer, gyroscope, etc.) that may be available on the user's mobile device (e.g. smartphone) or onboard vehicle device.

The above description is illustrative and not restrictive. Many variations of the invention will become apparent to those of skill in the art upon review of this disclosure. While the present invention has been described in connection with a variety of embodiments, these descriptions are not intended to limit the scope of the invention to the particular forms set forth herein. To the contrary, the present descriptions are intended to cover alternatives, modifications, and equivalents as may be included within the spirit and scope of the invention as defined by the appended claims and otherwise appreciated by one of ordinary skill in the art.

What is claimed is:

1. A method for generating a trucker parking report on available parking space(s), comprising:
receiving crowd sourced data from a computing device associated with a trucker traversing a travel route, the crowd sourced data including location data and available parking data associated with the user;
verifying accuracy and timeliness of the crowd sourced parking data,
recommending a parking space based on a stored trucker preference, the travel route and the crowd sourced parking data and generating a truck parking report, and
displaying the truck parking report on the computing device.

2. The method of claim 1, comprising displaying amenities associated with the parking space(s).

3. The method of claim 1, comprising displaying a route map to get to the parking space.

4. The method of claim 1, comprising displaying fuel pricing at the parking space.

5. The method of claim 1, comprising aggregating crowd-sourced information on truck stops, rest areas, weigh stations near the parking space(s).

6. The method of claim 1, comprising uploading the geographical location of the device to a market place.

7. The method of claim 1, comprising tracking geographical location of a device of a truck driver relative to a point of interest for each truck load.

8. The method of claim 1, comprising tracking driver rest period in the parking space.

9. The method of claim 1, comprising automatically discovering new loads or points of interest in proximity to a truck driver device.

10. The method of claim 1, comprising sending a notification to the device of a nearby position of the parking space, a nearby position of the load or a nearby position of a category of interest, the notification sent in response to proximity of the geographical location of the parking space relative to the position of the load.

11. The method of claim 1, comprising:
tracking geographical location of the trucker driver device relative to a point of interest for each truck load;
matching the geographical location of the device to a category of interest associated with the trucker and the truck load;
sending a notification to the device of a nearby position of the parking space, the nearby position of the load related to the category of interest, the notification sent in response to proximity of the geographical location of the device relative to the position of the load.

12. The method of claim 1, comprising automatically discovering new loads or points of interest in proximity to the truck driver device and one or more parking spaces.

13. The method of claim 12, comprising recommending a parking space based on parking space availability, parking space quality, and available loads for pickup.

14. The method of claim 1, comprising:
collecting performance information retrieved from a parking space rating database, wherein an associated rating and performance data for each parking space being identified as one of a subjective criteria and an objective criteria; and
generating a quality score to generate a performance quality score for the parking space using the associated rating and performance information, the performance quality score being increased if a number of positive ratings associated with the plurality of transactions are below a predetermined threshold.

15. The method of claim 1, comprising:
collecting performance information retrieved from a parking space rating database, wherein an associated rating and performance data for each parking space being identified as one of a subjective criteria and an objective criteria; and
generating a quality score to generate a performance quality score for the parking space using the associated rating and performance information, the performance quality score being lowered if a number of negative ratings associated with the plurality of transactions are below a predetermined threshold.

16. The method of claim 1, comprising matching a shipper with a trucker to transport a load.

17. The method of claim 1, comprising uploading a geographical location of the trucker.

18. The method of claim 1, comprising selecting a trucker or a shipper within a predetermined range of the parking space having at least a predetermined shipping performance rating.

19. The method of claim 1, comprising rendering a parking space with one of three colors, a first color indicating many parking spaces, a second color indicating limited number of parking spaces, and a third color indicating no parking space available.

20. A system for generating a trucker parking report on available parking space(s), comprising:
a server for receiving crowd sourced data from a computing device associated with a trucker traversing a travel route, the crowd sourced data including location data and available parking data associated with the user; the server verifying accuracy and timeliness of the crowd sourced parking data and recommending a parking space based on a stored trucker preference, the travel route and the crowd sourced parking data and generating a truck parking report, and
a mobile device wirelessly coupled to the server for displaying the truck parking report.
